(19) United States
(12) Patent Application Publication
(10) Pub. No.: US 2011/0117466 A1
(43) Pub. Date: May 19, 2011

(54) Solid Oxide Fuel Cell Systems

(76) Inventor: Michael Edward Badding, CAMPBELL, NY (US)

(21) Appl. No.: 12/991,748

(22) PCT Filed: May 20, 2009
(86) PCT No.: PCT/US09/03110

§ 371 Date: Nov. 9, 2010

Related U.S. Application Data
(60) Provisional application No. 61/130,475, filed on May 30, 2008.

(51) Int. Cl. H01M 8/04; H01M 8/24

(52) U.S. Cl. 429/435; 429/456; 429/434

(57) ABSTRACT

According to one embodiment of the present invention a fuel cell system comprises: (i) a plurality of fuel cell packets, each packet comprising at least one fuel inlet, at least one fuel outlet, a frame, and two multi-cell fuel cell devices, the fuel cell devices situated such that an anode side of one fuel cell device faces an anode side of another fuel cell device, and the two fuel cell devices, in combination, at least partially form a fuel chamber connected to the fuel inlet and the fuel outlet; (ii) a plurality of heat exchange packets, each packet comprising at least one oxidant inlet, at least one oxidant outlet, and an internal oxidant chamber connected to the at least one oxidant inlet and the least one oxidant outlet; the heat exchange packets being parallel to and interspersed between the fuel cell packets, such that the heat exchange packets face the fuel cell packets and form, at least in part, a plurality of cathode reaction chambers between the heat exchange packets and the fuel cell packets; (iii) a housing supporting and enclosing the fuel packets and the heat exchange packets; (iv) an oxidant inlet plenum operatively connected to oxidant inlets of the heat exchange packets; (v) an oxidant exhaust plenum operatively connected to the cathode reaction chambers; (vi) an inlet fuel manifold connected to fuel inlets of the fuel cell packets; and (vii) an exhaust fuel manifold connected to the fuel outlets of the fuel cell packets.

This application claims the benefit of priority to U.S. Patent Application Ser. No. 61/130.475, filed on May 30, 2008, the content of which is relied upon and incorporated herein by reference in its entirety.

This invention was made with Government support under Cooperative Agreement 70NANB4H3036 awarded by National Institute of Standards and Technology (NIST). The Government has certain rights in this invention.

### FIELD OF THE INVENTION

The present invention relates to solid oxide fuel cells and, more particularly, to systems and methods for managing the thermal energy produced by the electrochemical reactions within a reaction chamber.

### BACKGROUND

Recently, significant attention has been focused on fuel cells as clean energy sources capable of highly efficient energy conversion in an environmentally friendly manner. Solid oxide fuel cells (SOFC) are one type of fuel cell that work at very high temperatures, typically between 700° C. and 1000° C. Solid oxide fuel cells can have multiple geometries, but are typically configured in a planar geometry. In a conventional planar configuration, an electrolyte is sandwiched between a single anode electrode and a single cathode electrode. The sandwiched electrolyte is used as a partition between a fuel gas, such as hydrogen, which is supplied to a partition on the anode electrode side, and an air or oxygen gas, which is supplied to the partition on the cathode electrode side.

In a typical solid oxide fuel cell system, approximately one half of the kinetic energy of reactants, such as fuel and oxygen, is converted into electricity and the other half is converted to thermal energy, which causes a significant temperature increase within the SOFC system. In order to trigger fast electrochemical reactions, the reactants often must be heated to a high temperature. For example, in a system using a thin yttria-partially stabilized zirconia (3YSZ) electrolyte, the reactants have to be heated to approximately 725° C. to obtain an effective reaction. With such an initial temperature of reactants, the peak temperature within the fuel cell for a stoichiometric hydrogen-air system can rise to more than 1000° C.

The electrical and mechanical performance of fuel cells depends heavily on the operating temperature of the system. At high temperatures (such as about 1000° C. or more), serious issues may arise in the way of thermal mechanical stress and the melting of sealing materials within the solid oxide fuel cell system components. Furthermore, external heating is often needed to heat the reactants to their optimal reaction temperature, which results in low overall system efficiency.

Various thermal management strategies have been developed. For example, U.S. 2004/0170879A1 discloses a shape memory alloy structure that is connected to a fuel cell for thermal management. U.S. 2005/0014046A1 discloses an internal bipolar heat exchanger that is used to remove the heat from an anode side of an individual cell to heat the cathode flow of another cell. In U.S. 2004/0028972A1, a fluid heat exchanger is disclosed for transferring heat between fuel cell units and a heat exchanger fluid flow, which flows in a direction perpendicular to the electrolyte surface. Further, in U.S. 2003/017695A1, a reformer reactor is disclosed that is connected to a fuel cell for helping the thermal management at the system level. In WO2003065488A1, an internal reformer is disclosed for use in thermal management of a fuel cell.

Accordingly, there is a need in the art for thermal management systems and methods that are able to both reduce the thermal mechanical stress that results from the thermal energy generated in the reaction and preheat the reactants that enter the reaction chamber increase the overall system efficiency of the solid oxide fuel cell

### SUMMARY

According to one embodiment of the present invention a fuel cell system comprises:
a. a plurality of fuel cell packets, each packet comprising at least one fuel inlet, at least one fuel outlet, a frame, and two multi-cell fuel cell devices, the fuel cell devices situated such that an anode side of one fuel cell device faces an anode side of another fuel cell device, and the two fuel cell devices, in combination, at least partially form a fuel chamber connected to the fuel inlet and the fuel outlet;
b. a plurality of heat exchange packets, each packet comprising at least one oxidant inlet, at least one oxidant outlet, and an internal oxidant chamber connected to the at least one oxidant inlet and the least one oxidant outlet; the heat exchange packets being parallel to and interspersed between the fuel cell packets, such that the heat exchange packets face the fuel cell packets and form, at least in part, a plurality of cathode reaction chambers between the heat exchange packets and the fuel cell packets;
c. a housing supporting and enclosing the fuel packets and the heat exchange packets;
d. an oxidant inlet plenum operatively connected to oxidant inlets of the heat exchange packets;
e. an oxidant exhaust plenum operatively connected to the cathode reaction chambers;
f. an inlet fuel manifold connected to fuel inlets of the fuel cell packets; and
g. an exhaust fuel manifold connected to the fuel outlets of the fuel cell packets.

According to some exemplary embodiments, a fuel cell system may further include an oxidant turnaround plenum, the oxidant turnaround plenum being operatively connected to: the oxidant outlets of the heat exchange packets; and the oxidant inlet side of the cathode reaction chambers.

According to some exemplary embodiments, a fuel cell system may further comprise a secondary oxidant exhaust (i) connected to the alternative oxidant plenum; and (ii) comprising a valve capable of controlling backpressure in the alternative oxidant plenum.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed and/or as claimed.

### BRIEF DESCRIPTION OF THE DRAWINGS

The accompanying drawings, which are incorporated in and constitute a part of this specification, illustrate certain aspects of the instant invention and together with the description, serve to explain, without limitation, the principles of the invention.

FIG. 1 is a cut-away view of a modular solid oxide fuel cell system within an operating environment, according to one embodiment of the present invention.

FIG. 2A illustrates a fuel cell frame of a modular fuel cell packet, according to another embodiment of the present invention.

FIG. 2B is a cross-sectional view of Section A-A of the fuel cell packet frame of FIG. 2A.

FIG. 3 illustrates a modular fuel cell packet, according to one embodiment of the present invention.

FIGS. 4A and B illustrate a side wall of a modular oxidant heat exchange packet, according to other embodiment of the present invention.

FIG. 5 is a perspective, cross-sectional view of a modular solid oxide fuel cell system with modular oxidant heat exchange packets arranged therein, according to one exemplary embodiment of the present invention.

FIG. 6 is a perspective, cross-sectional view of a modular solid oxide fuel cell system with modular fuel cell packets and modular heat exchange packets arranged therein, according to another exemplary embodiment of the present invention.

FIG. 7 illustrates oxidant and fuel flow within a modular solid oxide fuel cell system, according to yet another exemplary embodiment of the present invention.

FIGS. 8A and 8B illustrates an exemplary embodiment of a fuel cell packet that incorporates an oxidant heat exchange cavity.

FIG. 9A is a schematic cross-sectional view of a portion of the modular fuel cell system, including housing, primary and secondary air outlets and an air diffuser.

FIGS. 9B and 9C illustrate a partially assembled modular fuel cell system of FIG. 9A.

FIG. 10A is a schematic cross-sectional view of a portion of the modular fuel cell system corresponding to FIG. 9A, and depicts a secondary air exhaust and an air turnaround diffuser.

FIG. 10B illustrates oxidant flow within a modular solid oxide fuel cell system of FIGS. 9A-9C and 10A.

FIG. 11 illustrates one embodiment of exemplary fuel cell system.

### DETAILED DESCRIPTION OF THE INVENTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “oxidant preheating chamber” includes embodiments having two or more such “oxidant preheating chambers” unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As briefly summarized above, the present invention provides systems and methods for managing temperature distribution within a modular solid oxide fuel cell device, and increasing overall system efficiency. These systems and methods can, in various embodiments, increase the efficiency of a solid oxide fuel cell system by utilizing thermal energy produced in reactions within the fuel cell device to preheat air and/or fuel gases entering the fuel cell device, thereby reducing and/or eliminating the need for an external preheating system.

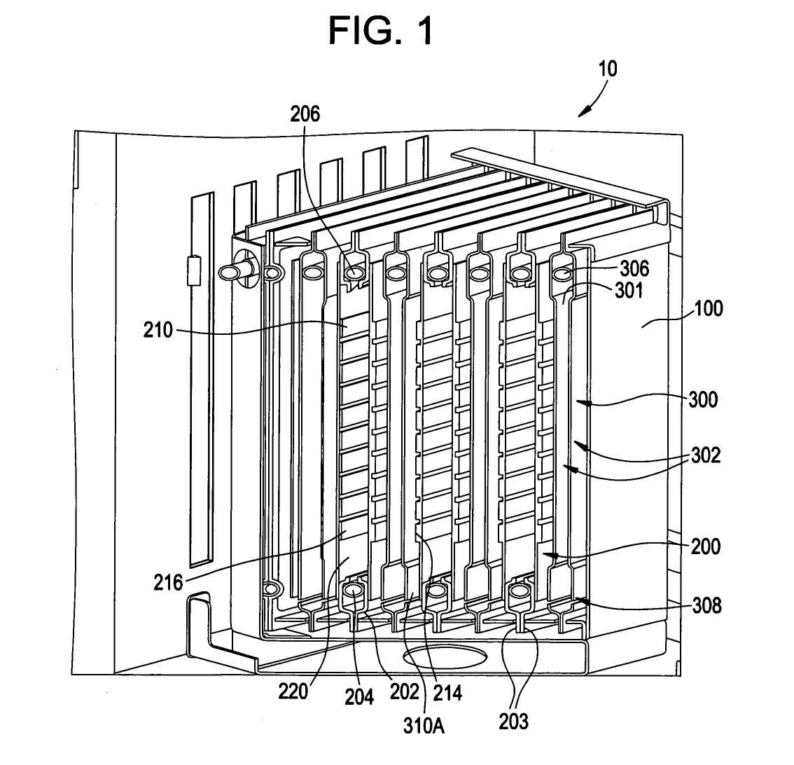

According to various embodiments of the present invention and as illustrated in FIG. 1, for example, a modular solid oxide fuel cell system 10 comprises a housing 100, at least one modular fuel cell packet 200, and at least one modular oxidant heat exchange packet 300. As illustrated in FIG. 1, a plurality of modular fuel cell packets 200 and a plurality of modular oxidant heat exchange packets 300 can be arranged within the housing 100 in an alternating array of fuel cell packets and oxidant heat exchange packets. Thus, in one particular embodiment, the fuel cell packets and heat exchange packets can be arranged such that each fuel cell packet is positioned in between two heat exchange packets. Therefore, in this configuration, a minimum number of packets are 1 fuel cell packet, and 2 heat exchange packets. The maximum number of packets is determined by the amount of output power required from the solid oxide fuel cell system.

Each fuel cell packet 200 incorporates a hermetically isolated fuel chamber situated inside the fuel cell packet that is formed between the two fuel cell devices (also referred to an electrode assemblies herein). More specifically, a fuel cell packet 200, according to various embodiments, can comprise a fuel cell packet frame 202 and at least one electrode assembly (i.e., a fuel cell device) 210. In the embodiment shown in FIG. 1, each fuel cell device 210 is a multi-cell device—i.e., each fuel cell device 210 comprises a plurality of arrayed fuel cells. In this particular embodiment, each fuel cell device is a planar, electrolyte supported fuel cell array.

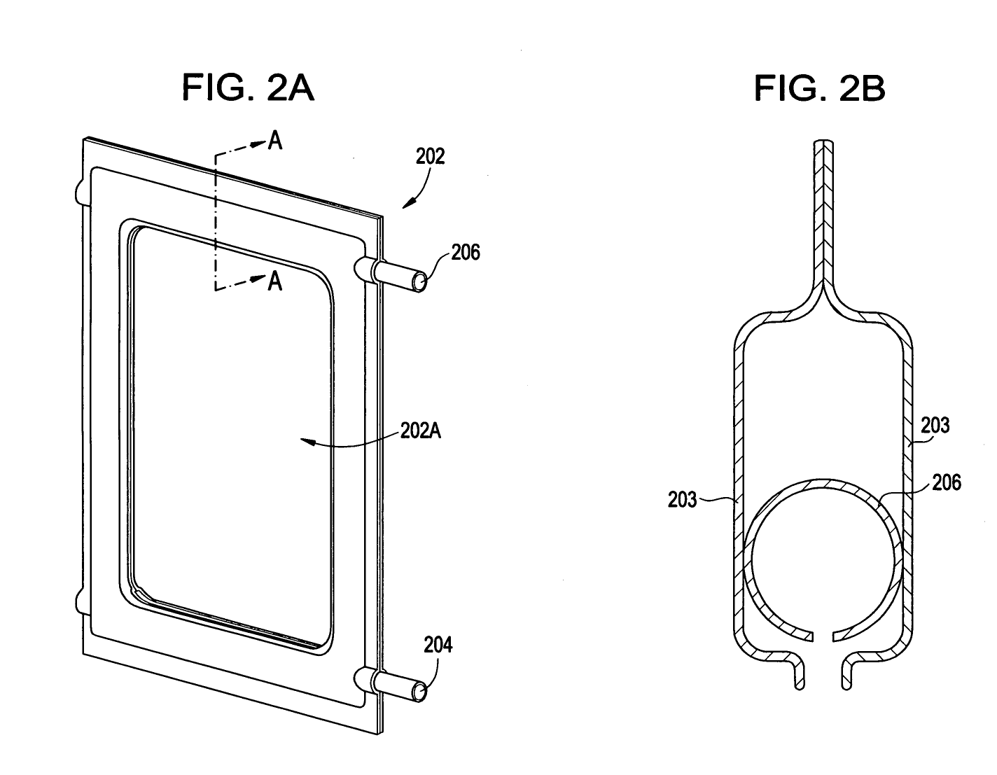

An exemplary fuel cell packet frame 202 is illustrated in FIGS. 2A and 2B. The fuel cell frame can be made of substantially rectangular stamped sheets of various materials. The fuel cell frame may be manufactured, for example, from stainless steel sheets 203, such as E-bright, or 446-stainless steel. Alternatively, a fuel cell frame may be made from glass, glass ceramic, fully or partially stabilized zirconia. Preferably, the coefficients of thermal expansion (CTE) of the frame material is close to that of the or the electrolyte material. (E.g., the CTE difference between the frame and the electrolyte materials is within 1×10-6 cm/°C., preferably, 0.6×10-6 cm/°C. , more preferably 0.4×10-6 cm/°C.) For example, each frame can be manufactured as a sheet and can have a substantially rectangular aperture 202A defined therein the inner portion of the sheet; thus, each sheet can define an inner periphery and an outer periphery. The sheet can be stamped, for example, in the portion of the sheet lying between the inner periphery and outer periphery, such as to form a well. As shown in FIG. 2B, the well can be shaped such that when the sheets 203 are adjoined, face-to-face, they make substantially full contact along portions of the outer periphery, but are at a spaced distance from each other along portions of the inner periphery. A fuel inlet 204 can be in fluid communication with the well formed in the lower portion of the fuel cell frame, such as shown in FIG. 2A. Similarly, a fuel outlet 206 can be in fluid communication with the well formed in the upper portion of the fuel cell frame.

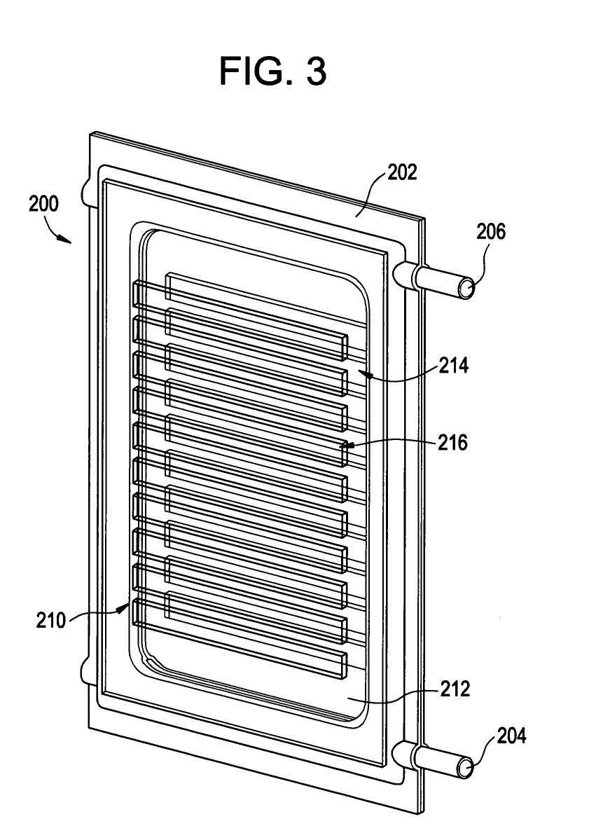

A fuel cell packet 200, according to further embodiments, can comprise at least one fuel cell device 210 (also referred to as electrode assembly herein). With reference to FIG. 3, an electrode assembly can comprise an electrolyte sheet 212 that can be a substantially planar sheet with a first surface and an opposing second surface. A plurality of anodes 214 can be disposed on the first surface and a plurality of cathodes 216 can be disposed on the opposed second surface, forming a multi-cell fuel cell device. A second electrode assembly can be similarly formed. In one embodiment, the fuel cell frame 202 can support the first and second electrode assemblies 210 such that the first and second electrode assemblies (i.e., fuel cell devices) 210 are separated from one another at a spaced distance. In a further embodiment, the first and second electrode assemblies 210 are supported by the frame 202 such that the respective first surfaces of the first and second electrode assemblies 210 face each other and define an anode chamber 220 (i.e., fuel chamber). As described above, the fuel cell frame 202 can be formed of a stamped material (or, alternatively, can be made from glass or glass ceramic) in such a manner that portions of the sheets of the fuel cell frame are at a spaced distance d from each other along the inner periphery. This distance d made be, for example, 0.5 mm or more. A typical distance may be, for example 1 mm to 7 mm. In this manner, there can be fluid communication from the fuel inlet 204, through the well formed in the lower portion of the fuel cell frame, and into the anode chamber (also referred to as a fuel chamber herein). Likewise, there can be fluid communication from the anode chamber, through the well formed in the upper portion of the fuel cell frame, and to the fuel outlet 206 of the fuel cell packet 200.

According to an embodiment of the present invention the direction of fuel flow in the fuel cell packets 200 is substantially in the direction of gravity. The frames 202 of fuel cell packets may be fabricated, for example, from formed stainless steel alloy with a wall thickness of no more than 1 mm, for example 0.25 mm −1 mm.

In one embodiment, the plurality of cathodes react 216 with an oxidant, such as oxygen-containing air, to produce oxygen ions. The plurality of anodes 214 use the oxygen ions produced by the cathode 216 to react with fuel (such as, but not limited to, hydrogen gas) to produce water and electricity. The electrolyte sheet 212 acts as a membrane or barrier, separating the oxidant on the cathode side from the fuel on the anode side. In this configuration, the electrolyte sheet 212 can also serve as an electrical insulator that prevents electrons resulting from the oxidation reaction on the anode side from reaching the cathode side. In a further embodiment, the electrolyte sheet 212 can be configured to conduct the oxygen ions, produced by the cathodes 216, to the anodes 214.

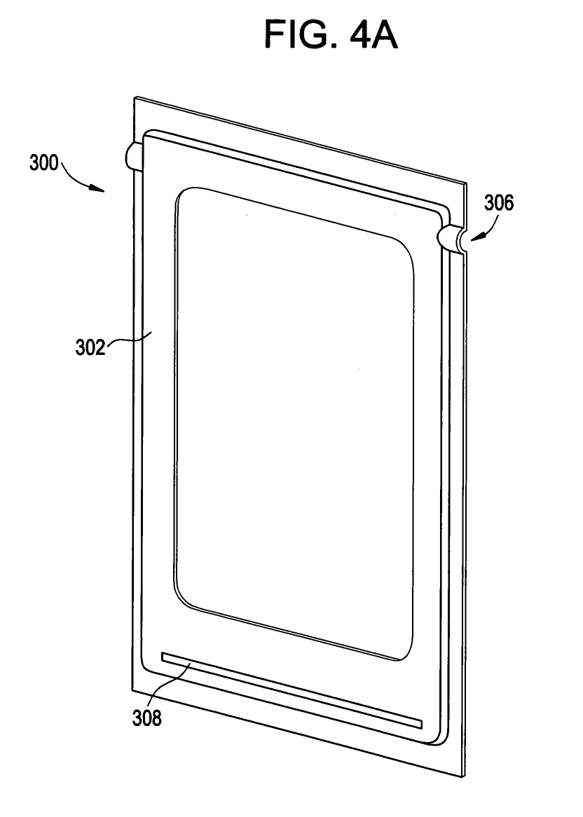

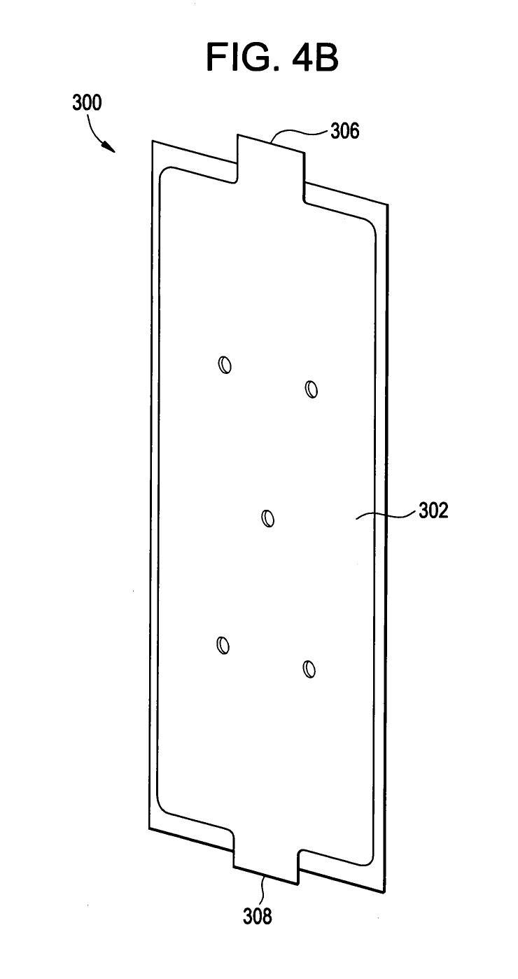

A modular solid oxide fuel cell system, according to some embodiments, further comprises a plurality of modular oxidant heat exchange packets 300. A modular oxidant heat exchange packet can comprise a body having a pair of opposed, spaced side walls 302 that are respectively positioned to define an interior volume 301 (i.e., air chamber), also referred to as a heat exchange cavity herein. FIGS. 4A and 4B illustrate a side wall 302 of an exemplary modular oxidant heat exchange packet 300. The walls 302 of the modular oxidant heat exchange packet may be manufactured, for example, from stainless steel such as E-bright, or 446 stainless steel, or a nickel alloy, or may be made from glass, glass ceramic, fully or partially stabilized zirconia. The walls 302 may be fabricated from formed stainless steel alloy with a thickness not greater than 1 mm. The walls 302 may be formed, for example, from formed stainless steel alloy with a wall thickness of no more than 1 mm, for example 0.1 mm to 1 mm. The walls 302 of the heat exchange packets 300 may comprise two formed alloy structures (walls) that abut each other, but not constrained such that each of these structure (wall) can slip relative to each other under conditions of thermal gradients.

As can be seen, a portion of the side walls can be formed to define an oxidant inlet 306 in communication with the interior volume (internal air chamber) 301, which serves as an oxidant preheating chamber, or the heat exchange chamber. The side walls 302 can further define at least one outlet 308 in communication with the interior volume 301. In a particular embodiment (see FIG. 4A), the outlet is a substantially horizontal slit defined in the lower portion of the side wall 302. In another embodiment (see FIG. 4B) the oxidant outlet 308 is similar in shape to the oxidant inlet 306. The heat exchange packets 300 do not need to be hermetically sealed, and do not need to be CTE matched to the fuel cell devices.

The heat exchange packets 300 may be comprised of a frame and two planar electrolyte sheets, the electrolyte sheets being arranged substantially parallel to one another, such that the cavity between them defines a the interior volume (heat exchange chamber) 301.

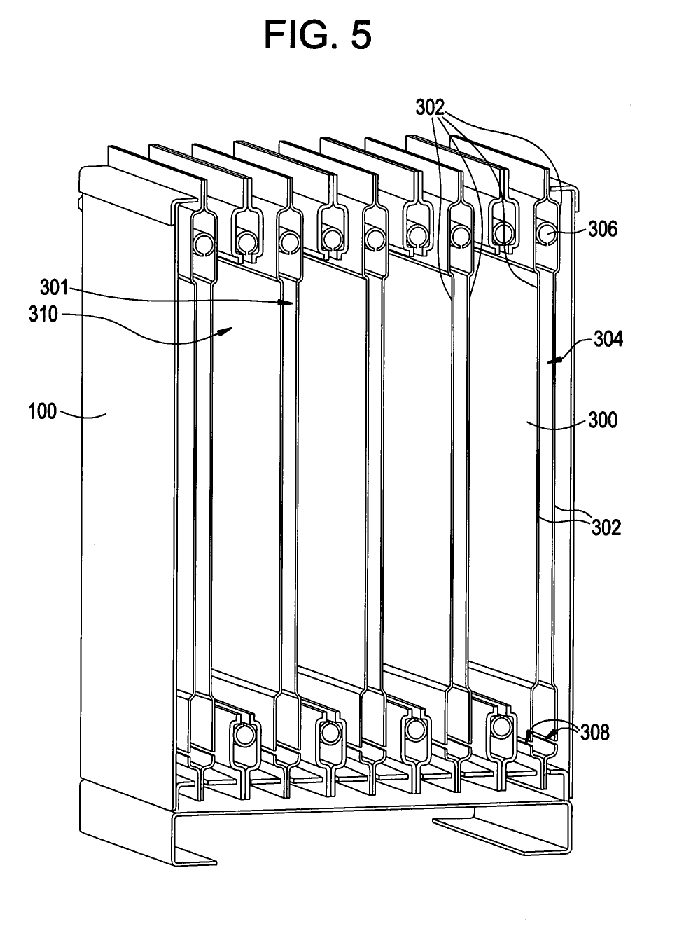

As illustrated in FIG. 5, a plurality of modular oxidant heat exchange packets 300 can be supported by the housing 100. In one embodiment, at least two heat exchange packets 300 can be positioned within the housing 100 in spaced opposition with each other, to define an oxidant chamber 310 therebetween. In a particular embodiment, the modular oxidant heat exchange packets 300 are positioned substantially vertically within the housing, such as shown in FIG. 5.

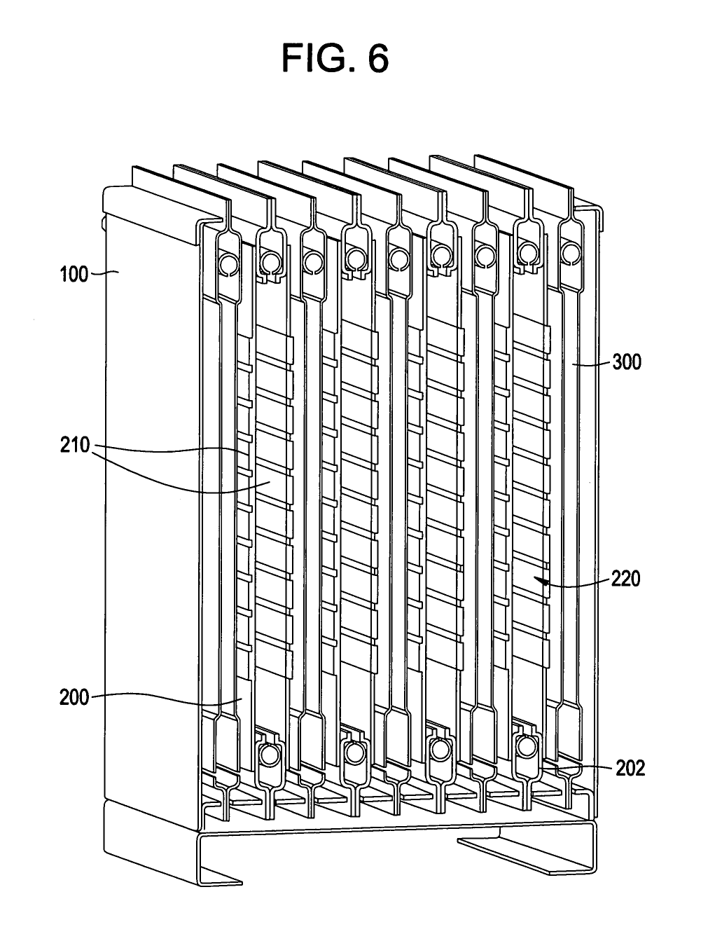

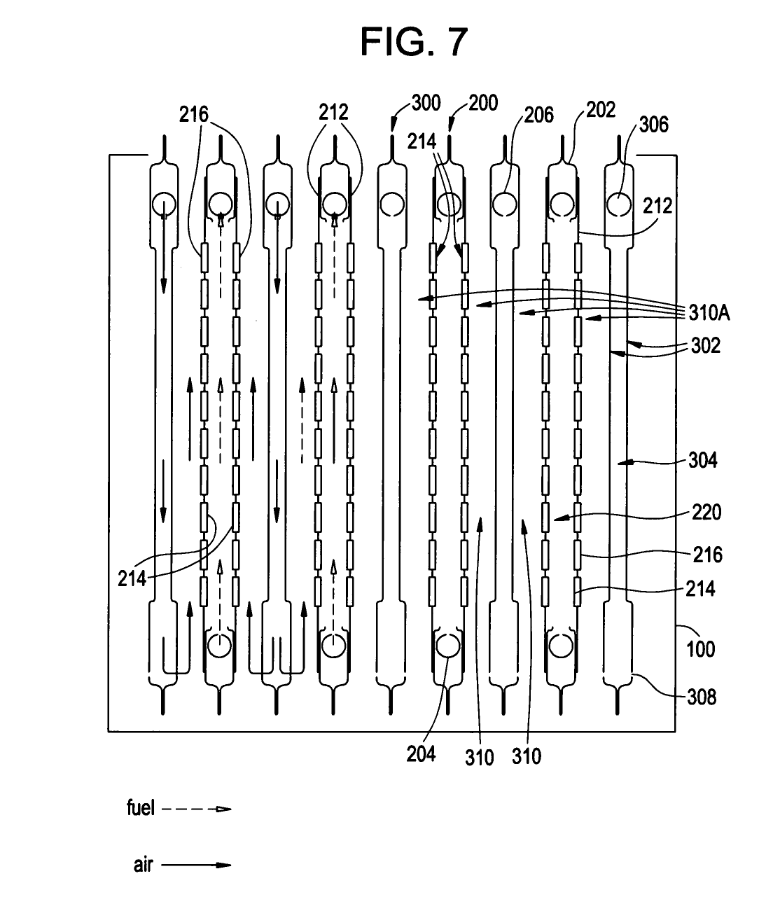

The housing 100 can similarly support at least one modular fuel cell packet, such as shown in FIGS. 6 and 7. In a particular embodiment, the at least one modular fuel cell packet 200 is positioned in between and in spaced relation to a pair of modular oxidant heat exchange packets 300 (e.g., within the oxidant chamber 310), thus forming cathode reaction chamber(s) 310A situated between the walls of the fuel cell packets 200 and the walls of the heat exchange packets 300. That is, the heat exchange packet 300 faces the cathode side(s) of the fuel cell devices 210 of the modular fuel cell packets 200. Spaces (wall to wall) between adjacent packets may be, for example, of about 0.5 mm to 7 mm, more preferably 1 mm to 5 mm. According to various embodiments, a modular solid oxide fuel cell device can comprise “n” fuel cell packets and “n+1” modular oxidant heat exchange packets. For example, a modular solid oxide fuel cell device can comprise one (1) modular fuel cell packets and two (2) modular oxidant heat exchange packets. In another embodiment, “n” can be at least two (2), such that a modular solid oxide fuel cell device can comprise at least two (2) modular fuel cell packets and at least three (3) modular oxidant heat exchange packets. It is contemplated that, according to various embodiments, a modular solid oxide fuel cell can comprise any number of modular fuel cell packets and any number of modular oxidant heat exchange packets and is not intended to be limited to the specific numbers referred to herein.

FIG. 7 illustrates schematically the exemplary flow of an oxidant, such as air, and fuel within a modular solid oxide fuel cell system that utilizes heat exchange packets similar to that shown in FIG. 4A. As illustrated, air enters the device via the oxidant inlet 306 of at least one of the modular oxidant heat exchange packets 300. In this embodiment, the air flows downwardly (i.e., in direction of gravity) through the heat exchange packet (i.e., through the interior volume 301 formed therein) and exits the oxidant chamber via the outlet 308. The air then passes through the oxidant chamber 310 (and thus through the cathode reaction chamber 310A) along the cathode side or surface of the modular fuel cell packet positioned next to the heat exchange packet. As described above, the air or oxidant reacts with the cathodes 216 to produce oxygen ions, which are conducted through the electrolyte sheet 212 to the anode side or surface. Fuel, such as but not limited to hydrogen gas, enters the modular fuel cell packet 200, specifically into the anode chamber 220, via the fuel inlet 204. The fuel reacts with the oxygen ions at the anodes to form water and electricity. The products of this reaction (e.g., exhaust gas) exit the anode chamber via the outlet 206.

As illustrated in FIG. 7, with respect to a modular heat exchange packet 300 that is positioned between two modular fuel cell packets 200 (the air passing through the interior volume 304 of the heat exchange packet can exit via the outlets 308 defined in each side wall 302 of the respective heat exchange packet. In this manner, air can pass through the oxidant chamber 310 along the cathode side of each of the fuel cell packets 200 that faces the respective heat exchange packet 300. Thus, the walls of the fuel cell packet 200 and the walls of the adjacent respective heat exchange packets (oxidant heat exchange packets) 300 provide, in part, cathode reaction chambers 310A in which air flows between the walls of the fuel cell packet 200 and the walls of the adjacent respective heat exchange packets 300. The heat exchange packets 300 help control and/or minimize thermal gradients within the fuel cell packet(s) 200 and the fuel cell stack by transferring thermal energy generated by the fuel cell packet(s) 200 to cooler air within the heat exchange packets oxidant heat exchange packet(s) 300, for example by utilizing a radiant susceptor and spreader. That is, the walls of the heat exchange packets act as radient susceptors by radiant heat absorption, and then spread the heat and provide it to the oxidant inside the interior volume 301 of the heat exchange packets 300. For example, the heat is:
(i) first radiantly transferred from the fuel cell packet (the heat is generated along the electrolyte sheets of the modular fuel cell packets by the reaction of the fuel with the oxygen ions) to the air situated between the fuel cell packet(s) 200 and the heat exchange packet(s) 300—i.e., to the air within the oxidant chamber along the cathode side of each of the fuel cell packet(s) that faces the respective heat exchange packet;
(ii) conductively spread throughout the wall surface of the heat exchange packet(s) 300; and then
(iii) finally transferred to the incoming air via convection and/or gas phase conduction.

In the exemplary embodiment shown in FIG. 7, the air (or fuel in an alternate embodiment not described herein) is first preheated in by the heat release from the electrode assembly 210. The heat is first radiantly transferred from the fuel cell devices 210 or the side walls of the fuel packet(s) 200 to the alloy wall surface(s) of the heat exchange packet(s) 300, then is conductively spread throughout the walls of the heat exchange packet(s) 300, and finally transferred to the incoming air via convection and to a lesser extent gas phase conduction. Preferably, the temperature gradient can be maintained within 50° C., more preferably within 35° C., and most preferably within 25° C.

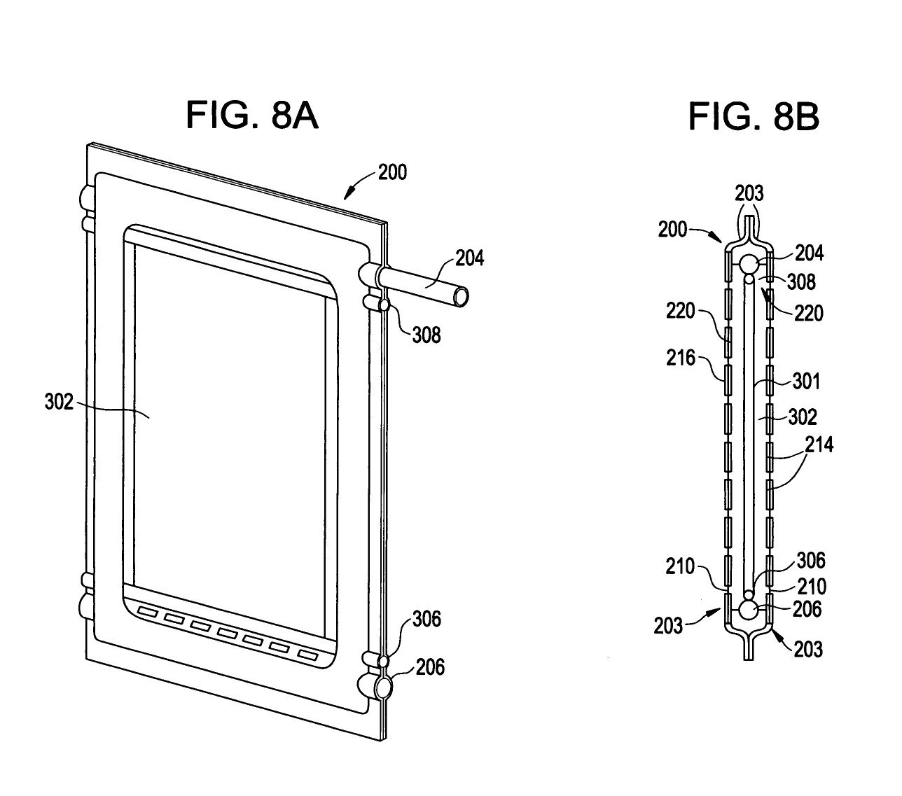

In an alternate embodiment the fuel packet 200 and internal heat exchange packet 300 can be integrated as shown in FIGS. 8A and 8B. FIG. 8A illustrates the frame of the fuel cell packet, without the fuel cell devices 210 mounted thereon. FIG. 8B illustrates schematically the cross-sectional view of the fuel cell packet, corresponding to FIG. 8A, but with the devices 210 mounted thereon. In the embodiment of FIGS. 8A and 8B the heat exchange cavity is the interior volume or the air chamber 301 which is situated between the anode reaction chambers 220 of the fuel cell packet 200. Thus, according to this embodiment, an integrated fuel cell packet comprises:
a. Two planar multi cell fuel cell devices 210 (i.e., two planar electrolyte-supported fuel cell arrays), the fuel cell devices 210 being arranged such that one anode side of one fuel device 210 faces the anode side of another fuel cell device 210;
b. A frame 202 supporting and/or disposed between the fuel cell devices 210 wherein this frame contains fuel inlet and exhaust ports 204, 206; air inlet and exhaust ports 306, 308; and one or more anode (i.e., fuel) chambers 220; and
c. An internal oxidant (e.g., air) chamber 301 disposed between the fuel cell devices 210, wherein the internal air chamber's walls 302 are substantially planar to the fuel cell devices 210, for the purpose of transferring and spreading thermal energy from the fuel cell devices 210 to the oxidant gas passing through the internal air chamber 301 (i.e., the oxidant preheating chamber). That is, the walls 302 of the fuel cell packet illustrated in FIG. 8B are capable of transferring and spreading thermal energy from the fuel cell devices 210 to the oxidant gas passing through the internal air chamber 301.

Utilizing this embodiment can decrease the overall volume of the fuel cell stack due to decreased spacing between the fuel cell packets, which provides advantages such as, for example, reduced weight, cost, and startup time/penalty.

According to various embodiments, the oxidant must be at a predetermined temperature in order to react with the cathodes, or in order to allow for a faster and/or more efficient electrochemical reaction with the cathodes. According to other embodiments, the fuel may also need to be at a predetermined temperature in order to react with the oxygen ions to produce the electricity. In one embodiment, the predetermined temperature of the supplied fuel, air, or both, can be any temperature greater than 600° C., such as approximately 600° C. −1000° C. Optionally, the predetermined temperature of the fuel, air, or both, can be in the range of from about 650° C. to about 900° C., preferably 700° C. to about 900° C., or 650° C. to 800° C.

In a particular embodiment, the air or oxidant that is initially provided to the modular fuel cell system can be preheated to a specific predetermined temperature. Optionally, heat is generated along the electrolyte sheets 212 of the modular fuel cell packets 200 by the reaction of the fuel with the oxygen ions. The thermal energy produced can be conducted through the side walls of each of the modular heat exchange packets 300 to preheat the air passing therethrough. Thus, in one embodiment, the modular heat exchange packets 300 can be comprised of a material having a predetermined thermal conductivity. Therefore, in one embodiment, the thermal energy that is produced by the reactions of the fuel cell packets can be used to preheat the oxidant, which is needed to produce the reactions. As described above, the oxidant can be preheated by an external preheating means in order to initially start the process. However, it is contemplated that upon an initial reaction at a fuel cell packet 200, the modular solid oxide fuel cell system can be substantially self-sustaining without the need for external heating means for either the oxidant or the fuel or both. Thus, once an initial reaction has occurred within the modular solid oxide fuel cell system, relatively cooler air can be brought into the fuel cell system via the inlets of the heat exchange packets 300, and this air can be progressively heated as it passes therethrough and can reach the necessary predetermined temperature by the time that the air passes along and reacts with the cathodes 216.

As may be appreciated by one skilled in the art, as the reactions occur within the modular solid oxide fuel cell system 10, the components therein will endure thermal expansion and/or contraction. In one embodiment, due to the spatial separation between each of the modular heat exchange packets 300 and each of the modular fuel cell packets 200, each of the packets can expand at varying rates without interfering with the other packets. In one embodiment, for example, the modular heat exchange packets have walls that can comprise a material having a higher coefficient of thermal expansion (CTE) than that of the frame of the modular fuel cell packets, for instance. Thus, the modular heat exchange packets may experience larger thermal gradients than those experienced by the fuel cell packets, and thus can move independently of the fuel cell packets and avoid interfering therewith.

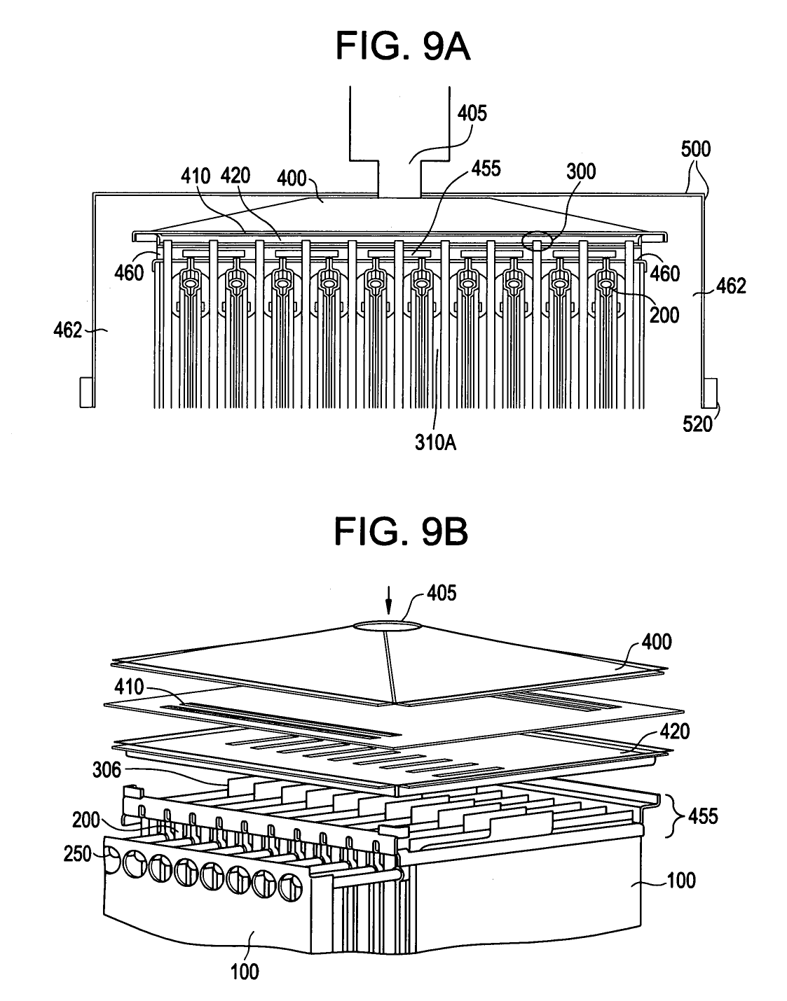

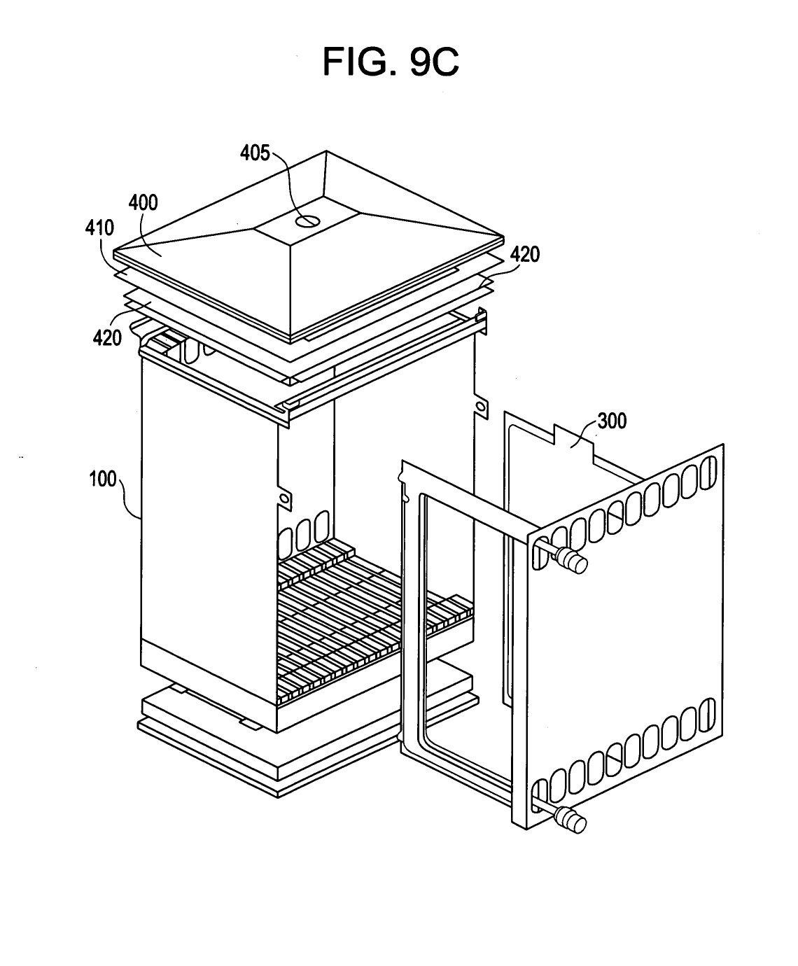

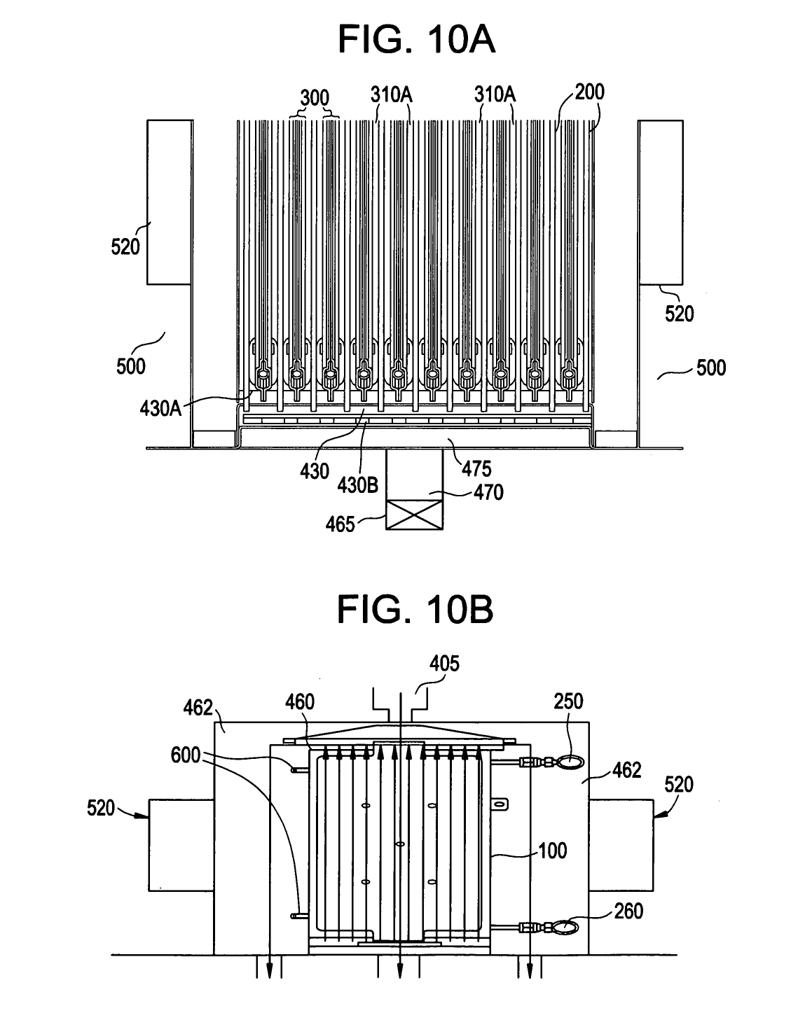

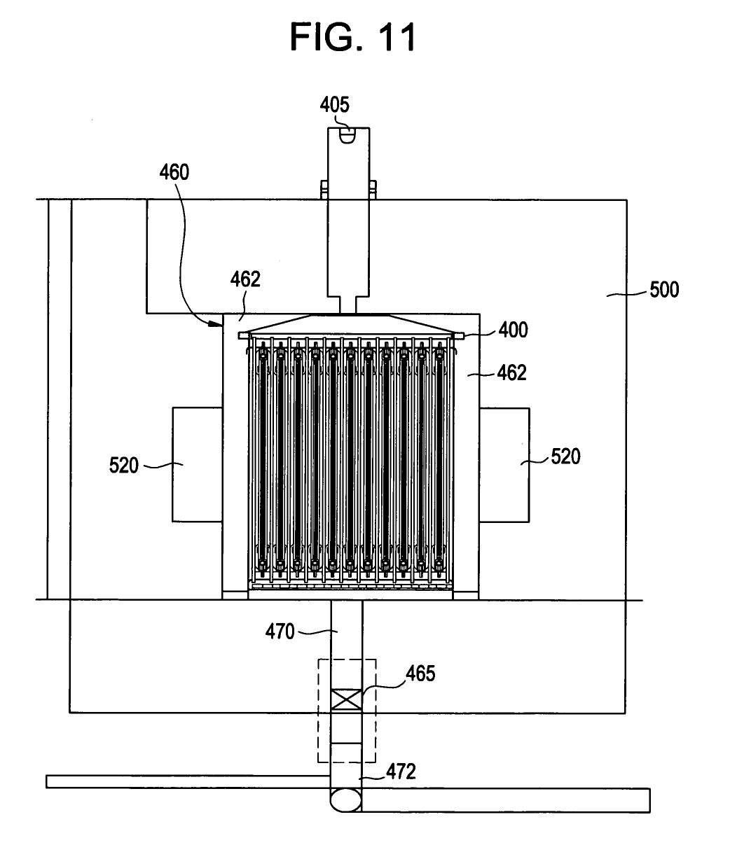

One exemplary embodiment of the modular solid oxide system 10 is shown in FIGS. 9A-9C. More specifically, FIGS. 9A and 9B illustrate the top portion of the modular solid oxide system 10, while FIG. 9C illustrates the housing oxidant propagating components. In this embodiment, cooler oxidant (air) enters the primary oxidant inlet plenum 400 through an air inlet 405, then passes through the inlet air diffuser plate(s) 410, and enters the secondary inlet plenum 420 in which the air is now distributed across the inlets 306 of the heat exchange packets 300. The diffuser plate(s) disperse oxidant to the heat exchange packets 300. The oxidant, or air, after picking up heat through the heat exchange packets 300 as described above, then exits the heat exchange packets 300 and enters the oxidant turnaround plenum 430 which may include at least one diffuser plate 430A and/or 430B, and is distributed before entering the cathode reaction chambers 310A as shown in FIGS. 10A and 10B. The air then exits the cathode reaction chambers 310A, enters the primary oxidant (air) exhaust plenum 455 before exhausting through the primary air exhaust ports 460 (see, for example FIG. 11), from which it may enter the primary air exhaust plenum 462. The fuel cells 200 and the heat exchange packets 300 are supported by and within the housing 100, as shown, for example, in FIGS. 9A-9C and 10A-10B. It is noted that an inlet fuel manifold 250 is connected to the fuel inlets 204 of the fuel cell packets 200, providing fresh fuel for entry into the anode chamber 220. The fuel outlets 206 are connected to an exhaust fuel manifold 260 of the fuel cell packets, so that the “spent fuel” can flow out of the anode chamber 220 and into exhaust fuel manifold 260.

The modular solid oxide system 10 may include an alternate or secondary air exhaust path as shown FIGS. 10A and 10B. This alternate or secondary air exhaust path may be utilized to advantageously to allow to high flow rates of air at the air inlet 405 for thermal startup purposes, while controlling flow rates of oxidant entering the cathode reaction chambers 310A. This is accomplished through the use of a gate valve 465 (shown in FIG. 11) located at the secondary oxidant exhaust 470 of the secondary oxidant exhaust piping 472 (see, for example FIG. 11).

The gate valve 465 (in the closed position) will induce and/or control backpressure at the alternate oxidant (e.g., air) exhaust plenum 475 (FIGS. 10A and 10B) preferentially forcing the air through the cathode reaction chambers 310A. Alternately, an open gate valve 465 will reduce the backpressure (to below that of the primary exhaust path) such that the air flow path will now preferentially exhaust through the secondary oxidant exhaust 470. The air flow paths are shown (in cross-section) in FIGS. 10A and 10B. More specifically, when the gate valve 465 is closed the air will flow from air turn-around plenum 480 into air turn-around diffuser 485, forcing the air through the cathode reaction chambers 310A. When the gate valve 465 is open, some of the air will flow from air turn-around plenum 480 into air secondary exhaust 470 to reduce the backpressure in the cathode reaction chambers 310A. A fuel cell stack assembly 10 may thus be brought to operating temperature by distributing hot incoming oxidant throughout the stack cathode reaction chambers by regulated oxidant pressure (e.g. backpressure) of a secondary oxidant exhaust stream within the secondary exhaust 470.

Thermal insulation 500 (see FIGS. 10A, 10B, and 11, for example) is placed around the stack core (i.e., the stack of the alternating fuel and heat exchange packets, or the stack of fuel packets (See FIGS. 8A, 8B, which illustrates a fuel cell packet that contains an air chamber therein) for two reasons: (a) to form (in part) the primary air exhaust plenum 455 and/or (b) to thermally insulate the stack core, such that the heat generated by the operating fuel cell devices 210 can be used for preheating incoming air and to provide an isothermal environment. The incoming air may be preheated either inside the heat exchange packet(s) 300 or, alternatively, inside the internal air chamber 301 (i.e., inside the oxidant preheating chamber) of the fuel packet (such as that shown, for example, in FIGS. 8A, 8B).

The thermal insulation 500 surrounding the fuel cell stack core, may include and/or form: (i) an air cavity situated between the insulation and the stack core, or the primary air exhaust plenum 462; and (ii) an opening between the air cavity (or the primary air exhaust plenum 462) and ambient air. In some examplary embodiments the exhaust oxidant gas travels through the fuel cell stack core (between the fuel cell packets, for example) and insulation 500 prior to traveling through the opening between the air cavity and ambient air.

Radiant heating panels 520 surround the stack core for purposes of (a) assisting thermal startup, (b) assisting isothermal operation environment for the stack core, and (c) providing heat for non-operating standby conditions. The radiant heating panels 520 may be situated parallel to each face of the stack core. The radiant heating panels 520 could also be replaced by combustion heat exchangers or recuperators.

The a fuel cell system may also include s plurality of electrically conductive structures 600 (see FIG. 10B) formed to connect with the fuel cell packets and to create a high temperature electrically conductive path to/from each set of the fuel devices contained therein.

Thus, referring to FIGS. 9A-9C, 10A, 10B and 11, according to some exemplary embodiments a fuel cell system 10 includes:
a. A plurality of fuel cell packets 200, each packet 200 comprising a frame and two fuel cell devices 210 (e.g., two planar electrolyte-supported fuel cell arrays), the fuel cell devices 210 being arranged such that one anode side of one fuel cell device 210 faces the anode side of another fuel cell device 210 and the frame in combination with devices 210 forming an anode (fuel) chamber 220;
b. A plurality of heat exchange packets 300 including an interior volume (air chamber) 301, and each heat exchange packet 300 in combination with its adjacent heat exchange packet 300 forms an oxidant channel (chamber 310) that is substantially parallel to and interspersed between the heat exchange packets 300;
c. A housing 100 supporting and enclosing said fuel cell packets 200 and heat exchange packets 300 such that heat exchange packets 300 face the fuel cell packets 200 and in combination with the fuel cell packets 200 and the housing 100 form, at least in part, cathode reaction chamber(s) 310A;
d. An inlet oxidant plenum 400 connected to one side one or more diffuser plates 410 to disperse oxidant to heat exchange packets 300;
e. A primary oxidant exhaust plenum 455 operatively connected to the cathode reaction chamber(s) 310A for collecting “exhausted” oxidant from the cathode reaction chamber(s) 310A;
f. An inlet fuel manifold 250 connected to the fuel inlets 204 of the fuel cell packets 200, and providing fresh fuel for entry into the anode chamber 220; and
g. An exhaust fuel manifold 260 connected to the fuel outlets 206 of the fuel cell packets, so that the “spent fuel” can flow out of the anode chamber 220 and into exhaust fuel manifold 260.

As described above, a turnaround plenum 430 may be connected to (a) the oxidant outlets 308 of the heat exchange packets 300 and (b) the inlet side of the oxidant (cathode) reaction chambers 310A. The turn around plenum 430 may comprise, for example, and one or more diffuser plates 430A, 430B that are operatively connected to (a) the exhaust side of the heat exchange packets 300 and/or (b) the oxidant inlet side of the oxidant (cathode) reaction chambers 310A. The a fuel cell system 10 may also include a secondary oxidant exhaust manifold 470 connected to the alternative exhaust heat exchange plenum 475, and a valve 465 for controlling backpressure in the exhaust heat exchange plenum 475.

According to one embodiment, the fuel cell packets 200, heat exchange packets 300, housing 100, inlet oxidant plenum 400 and diffusers 410, oxidant exhaust plenum 455, oxidant exhaust manifold, inlet fuel manifold 450, and/or exhaust fuel manifold 460 comprise a glass, glass-ceramic or ceramic coating, for example an alumina coating. This coating prevents oxide volatization and may electrically isolate the fuel cells from the frames of the fuel cell packets 300.

It should be understood that while the present invention has been described in detail with respect to certain illustrative and specific embodiments thereof, it should not be considered limited to such, as numerous modifications are possible without departing from the broad spirit and scope of the present invention as defined in the appended claims.

1. A fuel cell system comprising:
a. a plurality of fuel cell packets, each packet comprising at least one fuel inlet, at least one fuel outlet, a frame, and two multi-cell fuel cell devices, said fuel cell devices situated such that an anode side of one fuel cell device faces an anode side of another fuel cell device and said two fuel cell devices, in combination, at least partially form a fuel chamber connected to said fuel inlet and said fuel outlet;
b. a plurality of heat exchange packets, each packet comprising at least one oxidant inlet, at least one oxidant outlet, and an internal oxidant chamber connected to said at least one oxidant inlet and the at least one oxidant outlet; said heat exchange packets being parallel to and interspersed between said fuel cell packets, such that the heat exchange packets face said fuel cell packets and form, at least in part, a plurality of cathode reaction chambers between said heat exchange packets and said fuel cell packets;
c. a housing supporting and enclosing said fuel packets and said heat exchange packets;
d. an oxidant inlet plenum operatively connected to oxidant inlets of the heat exchange packets;
e. an oxidant exhaust plenum operatively connected to said cathode reaction chambers;
f. an inlet fuel manifold connected to fuel inlets of the fuel cell packets; and
g. an exhaust fuel manifold connected to the fuel outlets of the fuel cell packets.

2. A fuel cell system according to claim 1, comprising: an oxidant turnaround plenum and including least one diffuser plate, said oxidant turnaround plenum being operatively connected to: the oxidant outlets of the heat exchange packets; and the oxidant inlet side of the cathode reaction chambers.

3. A fuel cell system according to claim 2, further comprising a secondary oxidant exhaust (i) connected to the alternative oxidant plenum; and (ii) comprising a valve capable of controlling backpressure in the alternative oxidant plenum.

4. A fuel cell system according to claim 1, further comprising a secondary oxidant exhaust (i) connected to the alternative oxidant plenum; and (ii) comprising a valve capable of controlling backpressure in the alternative oxidant plenum.

5. A fuel cell system according to claim 1 wherein said fuel cell packets are fabricated from stainless steel alloy with a thickness less than 1 mm.

6. A fuel cell system according to claim 1 wherein said heat exchange packets are fabricated from stainless steel alloy with a thickness less than 1 mm.

7. A fuel cell system according to claim 1 said heat exchange packets include a frame and two planar electrolyte sheets, said sheets being arranged parallel to one another, such that the internal chamber formed between said electrolyte sheets forms an oxidant preheating chamber.

8. A fuel cell system according to claim 1 wherein the direction of fuel flow in the fuel cell packets is substantially in the direction of gravity.

9. A fuel cell system according to claim 1 wherein said (1) fuel cell packets, (b) heat exchanger packets, (c) housing, (d) inlet oxidant plenum, (e) oxidant exhaust plenum, d, (f) inlet fuel manifold, and/or (g) exhaust fuel manifold include a coating capable of preventing oxide volatization.

10. A fuel cell system according to claim 1 comprising a fuel cell stack core, wherein said fuel cell stack core comprises of said plurality of fuel cell packets, said fuel cell system additionally comprising a thermal insulation surrounding fuel cell stack core, said thermal insulation comprising:
a. an air cavity located between said thermal insulation and said fuel cell stack core; and
b. an opening between said air cavity and ambient air.

11. A fuel cell system according to claim 10 wherein exhaust oxidant gas travels through said fuel cell stack core and said insulation prior to traveling through said opening.

12. A fuel cell system according to claim 11 wherein said thermal insulation additionally comprises embedded electrical heating panels parallel to each face of said fuel cell stack core.

13. A fuel cell packet comprising;
c. two planar electrolyte-supported fuel cell arrays, said arrays being arranged such that one anode side of one fuel cell array faces the anode side of another fuel cell array;
d. a frame disposed between said fuel cell arrays, wherein said frame contains fuel inlet and exhaust ports, air inlet and exhaust ports, and one or more fuel chambers;
e. an internal oxidant chamber disposed between said fuel cell arrays, said air chamber and having walls capable of transferring and spreading thermal energy from the fuel cell arrays to the oxidant passing through said internal oxidant chamber.

14. A heat exchange packet comprising two formed alloy walls abutting each other but not constrained, such that each wall can slip relative to another wall when subjected to thermal gradients.

15. A method of bringing a fuel cell stack to operating temperature, said method comprising the step of: distributing hot incoming oxidant throughout the cathode reaction chambers by regulating backpressure of a secondary exhaust stream.
